(19) United States
(12) Patent Application Publication
(10) Pub. No.: US 2024/0104477 A1
(43) Pub. Date: Mar. 28, 2024

(54) WAITING TIME PREDICTION SYSTEM, WAITING TIME PREDICTION METHOD, AND NON-TRANSITORY STORAGE MEDIUM

(71) Applicant: NEC Corporation, Tokyo (JP)

(72) Inventor: Kosuke Moriwaki, Tokyo (JP)

(73) Assignee: NEC Corporation, Tokyo (JP)

(21) Appl. No.: 18/232,114

(22) Filed: Aug. 9, 2023

(30) Foreign Application Priority Data
Sep. 22, 2022 (JP) 2022-150923

(51) Int. Cl. G06Q 10/0637; G06Q 10/0639

(52) U.S. Cl. CPC G06Q 10/06375; G06Q 10/06398

(57) ABSTRACT

To more accurately compute a waiting time until an ordered product is received and a service is received, the present invention provides a waiting time prediction system 10 including an image acquisition unit 11 that acquires an image in which a workspace of a worker in a store that provides a product or a service is captured; a work process determination unit 12 that determines which work process is performed by the worker at a point in time at which the image is captured, based on the image; and a waiting time computation unit 13 that computes a waiting time until a product or a service in the store is provided, based on a determination result of the work process.

This application is based upon and claims the benefit of priority from Japanese patent application No. 2022-150923, filed on Sep. 22, 2022, the disclosure of which is incorporated herein in its entirety by reference.

### TECHNICAL FIELD

The present invention relates to a waiting time prediction system, a waiting time prediction method, and a program.

### BACKGROUND ART

A technique related to the present invention is disclosed in Patent Documents 1 to 4.

Patent Document 1 (Japanese Utility Model No. 3079125) discloses a technique being used in a store that provides a vehicle service such as oil replacement and tire replacement, and being used for recognizing a progress situation of work, based on an input of a salesclerk, and notifying predetermined information to a customer according to the recognized situation.

Patent Document 2 (Japanese Patent Application Publication No. 2022-41715) discloses a technique for predicting an exit time of a customer and predicting a vacancy waiting time, based on the result.

Patent Document 3 (Japanese Patent Application Publication No. 2018-187746) discloses a technique for determining work being executed by an industrial robot used for production and assembly at a factory and the like.

Patent Document 4 (Japanese Patent Application Publication No. 2021-152979) discloses a technique for determining, by an image analysis, a work situation of a worker who performs work such as upkeep and maintenance at a work site.

### DISCLOSURE OF THE INVENTION

In various stores such as a fast-food store, a restaurant, a beauty salon, and a massage store, after a product and a service are ordered, a waiting time may occur until the product is received and the service is received. The waiting time is desired to be more accurately computed. Stress relief of a customer, an increase in sales by an increase in a customer that selects waiting, and the like are expected by providing a more accurate waiting time to the customer.

The technique disclosed in Patent Document 1 recognizes a progress situation of work, based on an input of a salesclerk. When such input work is requested from a salesclerk, there is a risk that progress of work related to provision of a product and a service becomes slow. Further, when a salesclerk fails to perform an input, a progress situation of work cannot be accurately recognized.

The technique disclosed in Patent Document 2 is a technique for predicting a waiting time until a seat is vacant. Awaiting time until a seat is vacant and a waiting time until a product is received and a service is received do not necessarily coincide with each other. The technique disclosed in Patent Document 2 cannot accurately predict a waiting time until an ordered product is received and a service is received.

The techniques described in Patent Documents 3 and 4 are a technique used at a factory, a work site, and the like. Such a technique cannot predict a waiting time until a product and a service provided by a store are received.

One example of an object of the present invention is, in view of the problem described above, to provide a waiting time prediction system, a waiting time prediction method, and a program that solve a challenge to more accurately compute a waiting time until an ordered product is received and a service is received.

One aspect of the present invention provides a waiting time prediction system including: an image acquisition unit that acquires an image in which a workspace of a worker in a store that provides a product or a service is captured;
a work process determination unit that determines which work process is performed by the worker at a point in time at which the image is captured, based on the image; and
a waiting time computation unit that computes a waiting time until a product or a service in the store is provided, based on a determination result of the work process.

One aspect of the present invention provides a waiting time prediction method including,
by one or more computers:
acquiring an image in which a workspace of a worker in a store that provides a product or a service is captured;
determining which work process is performed by the worker at a point in time at which the image is captured, based on the image; and
computing a waiting time until a product or a service in the store is provided, based on a determination result of the work process.

One aspect of the present invention provides a program causing a computer to function as:
an image acquisition unit that acquires an image in which a workspace of a worker in a store that provides a product or a service is captured;
a work process determination unit that determines which work process is performed by the worker at a point in time at which the image is captured, based on the image; and
a waiting time computation unit that computes a waiting time until a product or a service in the store is provided, based on a determination result of the work process.

One aspect of the present invention achieves a waiting time prediction system, a waiting time prediction method, and a program that solve a challenge to more accurately compute a waiting time until an ordered product is received and a service is received.

### BRIEF DESCRIPTION OF THE DRAWINGS

The above-described object, the other objects, features, and advantages will become more apparent from suitable example embodiment described below and the following accompanying drawings.

FIG. 1 is a diagram illustrating one example of a functional block diagram of a waiting time prediction system.

FIG. 2 is a diagram illustrating one example of a hardware configuration of the waiting time prediction system.

FIG. 3 is a diagram illustrating another example of a functional block diagram of the waiting time prediction system.

FIG. 4 is a diagram illustrating one example of a relationship between a plurality of pieces of work.

FIG. 5 is a diagram illustrating another example of a relationship between the plurality of pieces of work.

FIG. 6 is a diagram illustrating another example of a relationship between the plurality of pieces of work.

FIG. 7 is a diagram illustrating one example of a relationship between a plurality of work processes.

FIG. 8 is a diagram illustrating another example of a relationship between the plurality of work processes.

FIG. 9 is a diagram illustrating another example of a relationship between the plurality of work processes.

FIG. 10 is a diagram illustrating one example of order management information.

FIG. 11 is a diagram illustrating another example of the order management information.

FIG. 12 is a diagram illustrating one example of work information.

FIG. 13 is a diagram illustrating a configuration of a pre-provision order.

FIG. 14 is a flowchart illustrating one example of a flow of processing of the waiting time prediction system.

FIG. 15 is a flowchart illustrating another example of a flow of processing of the waiting time prediction system.

FIG. 16 is a flowchart illustrating another example of a flow of processing of the waiting time prediction system.

FIG. 17 is a diagram illustrating another example of a functional block diagram of the waiting time prediction system.

FIG. 18 is a diagram illustrating one example of work information for each salesclerk.

FIG. 19 is a diagram illustrating another example of a functional block diagram of the waiting time prediction system.

FIG. 20 is a diagram illustrating one example of information output from the waiting time prediction system.

### DESCRIPTION OF EMBODIMENTS

Hereinafter, example embodiments of the present invention will be described with reference to the drawings. Note that, in all of the drawings, a similar component has a similar reference sign, and description thereof will be appropriately omitted.

### First Example Embodiment

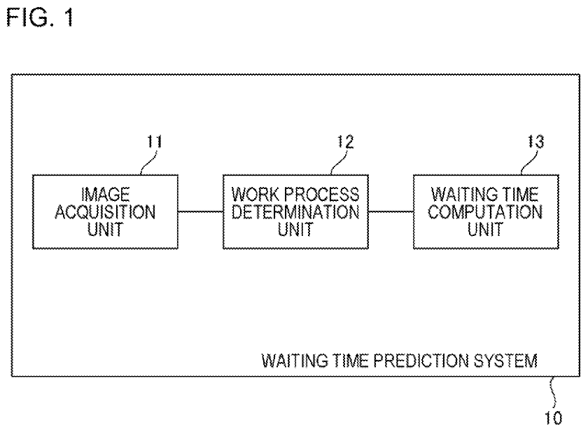

FIG. 1 is a functional block diagram illustrating an overview of a waiting time prediction system 10 according to a first example embodiment. The waiting time prediction system 10 includes an image acquisition unit 11, a work process determination unit 12, and a waiting time computation unit 13.

The image acquisition unit 11 acquires an image in which a workspace of a worker in a store that provides a product or a service is captured. The work process determination unit 12 determines which work process is performed by the worker at a point in time at which the image is captured, based on the image. The waiting time computation unit 13 computes a waiting time until the product or the service in the store is provided, based on the determination result of the work process.

Such a waiting time prediction system 10 solves a challenge to more accurately compute a waiting time until an ordered product is received and a service is received.

### Second Example Embodiment

### “Overview”

A waiting time prediction system 10 according to the present example embodiment is acquired by embodying the waiting time prediction system 10 according to the first example embodiment.

The waiting time prediction system 10 has a characteristic that the waiting time prediction system 10 determines a work process being performed by a worker in a store at a current point in time by using an image analysis technique, and computes a waiting time (hereinafter, may be simply referred to as the “above-described waiting time”) until a product or a service in the store is provided, based on the determination result. Hereinafter, a configuration of such a waiting time prediction system 10 will be described in detail.

### “Hardware Configuration”

Next, one example of a hardware configuration of the waiting time prediction system 10 will be described. Each functional unit of the waiting time prediction system 10 is achieved by any combination of hardware and software concentrating on a central processing unit (CPU) of any computer, a memory, a program loaded into the memory, a storage unit such as a hard disc that stores the program (that can also store a program downloaded from a storage medium such as a compact disc (CD), a server on the Internet, and the like in addition to a program previously stored at a stage of shipping of an apparatus), and a network connection interface. Then, various modification examples of an achievement method and an apparatus thereof are understood by a person skilled in the art.

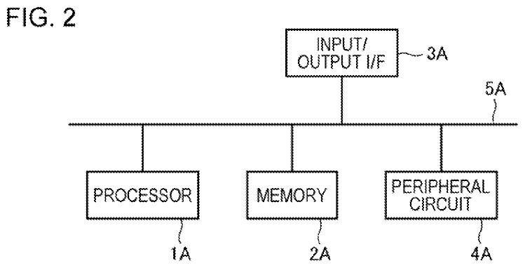

FIG. 2 is a block diagram exemplarily illustrating a hardware configuration of the waiting time prediction system 10. As illustrated in FIG. 2, the waiting time prediction system 10 includes a processor TA, a memory 2A, an input/output interface 3A, a peripheral circuit 4A, and a bus 5A. Various modules are included in the peripheral circuit 4A. The waiting time prediction system 10 may not include the peripheral circuit 4A. Note that the waiting time prediction system 10 may be formed of a plurality of apparatuses being separated physically and/or logically. In this case, each of the plurality of apparatuses can include the hardware configuration described above.

The bus 5A is a data transmission path for the processor TA, the memory 2A, the peripheral circuit 4A, and the input/output interface 3A to transmit and receive data to and from one another. The processor TA is an arithmetic processing apparatus such as a CPU and a graphics processing unit (GPU), for example. The memory 2A is a memory such as a random access memory (RAM) and a read only memory (ROM), for example. The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor TA can output an instruction to each of modules, and perform an arithmetic operation, based on an arithmetic result of the modules.

### “Functional Configuration”

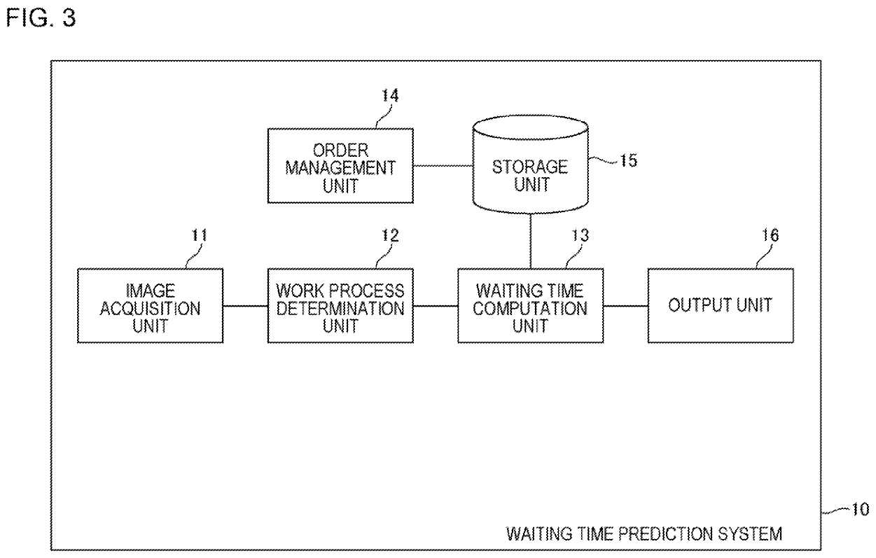

Next, a functional configuration of the waiting time prediction system 10 according to the present example embodiment will be described in detail. FIG. 3 illustrates one example of a functional block diagram of the waiting time prediction system 10. As illustrated, the waiting time prediction system 10 includes an image acquisition unit 11, a work process determination unit 12, a waiting time computation unit 13, an order management unit 14, a storage unit 15, and an output unit 16.

The image acquisition unit 11 acquires an image in which a workspace of a worker in a store that provides a product or a service is captured.

A type of the “store” is not particularly limited, and the waiting time prediction system 10 can be used in stores of various types of business. As the store, for example, a fast-food store, a restaurant, a beauty salon, a massage store, and the like are exemplified, which are not limited thereto.

The “worker” is a person who performs work related to provision of a product or a service. The work related to provision of a product or a service is, for example, cooking of a product, manufacturing of a product, packing of a product, packaging of a product, bagging of a product, service provision, and the like.

The “workspace” is a place where the worker performs the work related to provision of a product or a service.

The image acquisition unit 11 acquires, in real time, an image generated by a camera. A configuration for acquiring, in real time, an image generated by the camera is achieved by using various known techniques.

The camera captures the workspace of the worker. The camera is configured to capture any capturing target that can determine a work process being performed by the worker. As the capturing target, the worker, a hand of the worker, a work target object (such as a product and a material), a tool, a worktable, and the like are exemplified, which are not limited thereto.

The camera may be a stationary camera fixed in a predetermined position. In addition, the camera may be a wearable camera worn by the worker. In addition, the camera may be a camera included in a robot including an autonomous movement mechanism. The camera may continuously capture a moving image, or repeatedly capture a still image at a predetermined timing.

The work process determination unit 12 determines which work process is performed by the worker at a point in time at which the image is captured, based on the image acquired by the image acquisition unit 11.

First, a concept of the “work process” will be described. The store provides at least one product or service to a customer. In order to provide each product or service, at least one piece of work needs to be performed. Then, each piece of work is formed of at least one work process.

There are various ways to define the work and the work process. For example, for providing a product “grilled meat box lunch”, “rice serving” work, “grilled meat cooking” work, “side dish arrangement” work, “packing” work, and the like need to be performed. Then, for example, the “grilled meat cooking” work is formed of a work process such as “meat measuring”, “stir-frying”, “seasoning”, and “arrangement”.

Further, for providing “cut & shampoo” being a service provided in a beauty salon, “consulting” work before cut, “cut” work, “shampoo” work, and the like need to be performed. Then, for example, the “shampoo” work is formed of a work process such as “rinsing”, “washing”, and “drying”.

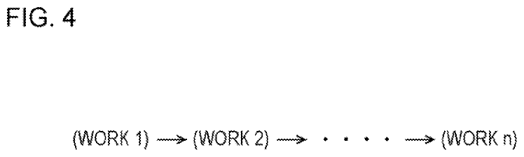

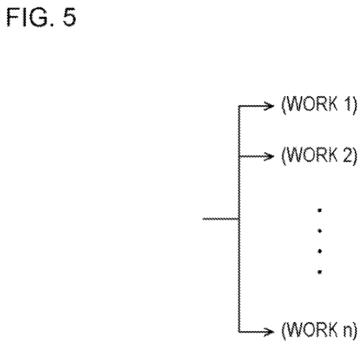

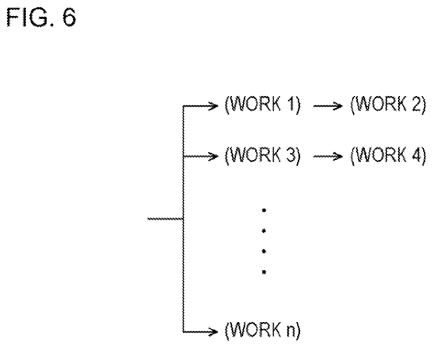

As illustrated in FIG. 4, a plurality of pieces of work needed for providing one product or service may be performed in a predetermined order being predefined. In addition, as illustrated in FIG. 5, a processing order may not be particularly defined, and the plurality of pieces of work may be able to be executed in any order. In addition, as illustrated in FIG. 6, a processing order of a part of the plurality of pieces of work may be defined, a processing order of a part of the plurality of pieces of work may not be defined, and the plurality of pieces of work may be able to be executed in any order.

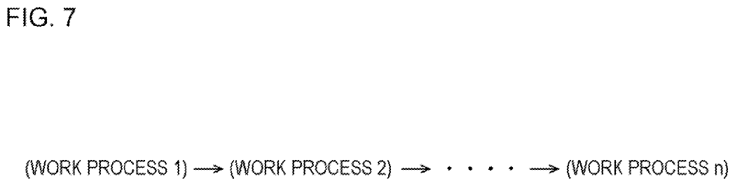

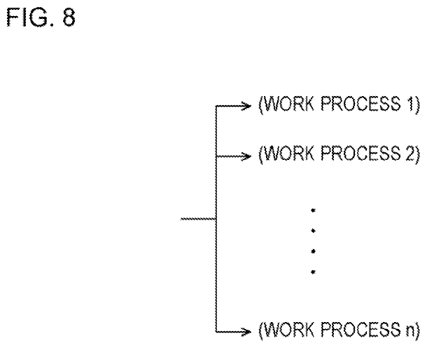

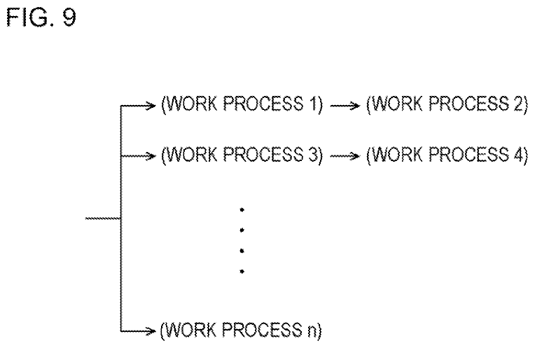

Similarly, as illustrated in FIG. 7, a plurality of work processes constituting one piece of work may be performed in a predetermined order being predefined. In addition, as illustrated in FIG. 8, a processing order may not be particularly defined, and the plurality of work processes may be able to be executed in any order. In addition, as illustrated in FIG. 9, a processing order of a part of the plurality of work processes may be defined, a processing order of a part of the plurality of work processes may not be defined, and the plurality of work processes may be able to be executed in any order.

Next, processing of determining, by an image analysis, which work process is performed by a worker at a point in time at which an image is captured will be described. A characteristic of an appearance of a work target object, a characteristic of a worktable, a surrounding characteristic of the work target object, a characteristic of a position of the work target object, a characteristic of a hand of the worker, a characteristic of a tool to be used, and the like when each of the plurality of work processes is performed are registered in advance. By searching for an image and detecting the characteristics, the work process determination unit 12 can determine a work process being performed at a point in time at which each image is captured.

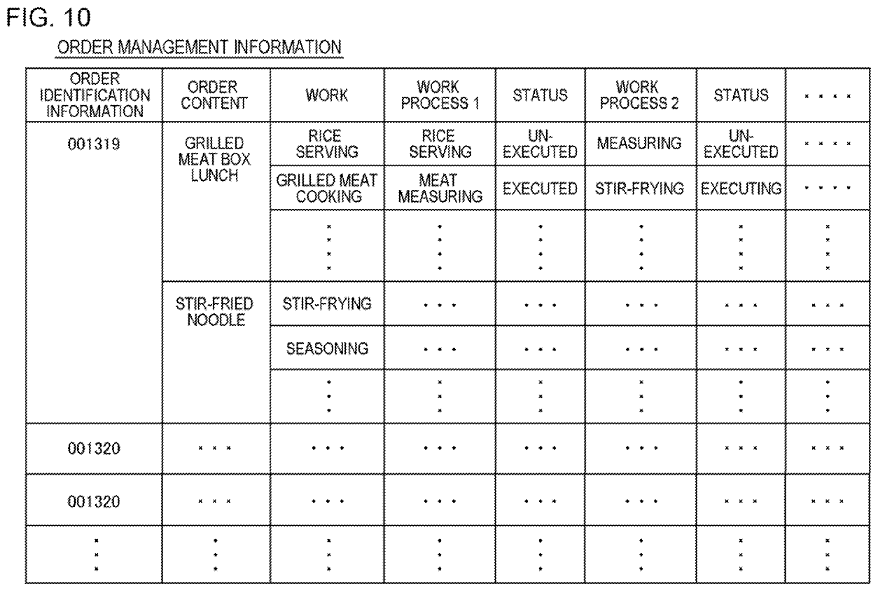

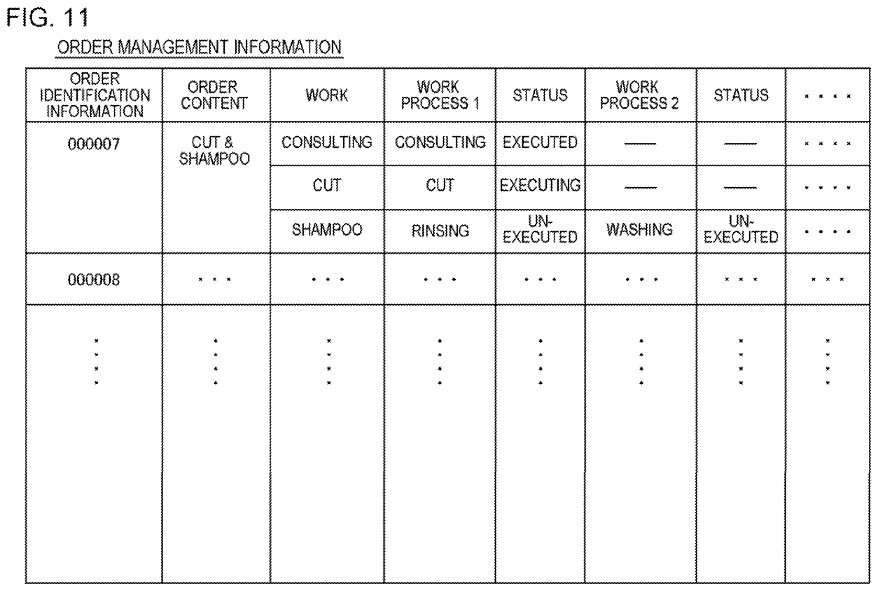

The order management unit 14 manages order management information indicating a “received order before a product or a service is provided (hereinafter, may be referred to as a “pre-provision order”)” and an “order content of each pre-provision order”. Management of the order management information performed by the order management unit 14 includes “addition of a new pre-provision order”, “status management of a pre-provision order”, “deletion of a pre-provision order in which provision is completed”, and the like. Hereinafter, each piece of processing will be described by using one example of the order management information illustrated in FIGS. 10 and 11. FIG. 10 is an example of the order management information when the waiting time prediction system 10 is used in a box lunch store, for example. FIG. 11 is an example of the order management information when the waiting time prediction system 10 is used in a beauty salon, for example. The order management information is stored in the storage unit 15.

### —Addition of New Pre-Provision Order—

The order management unit 14 acquires information indicating an order content of a newly received order from a terminal apparatus. The order content indicates at least one ordered product or service.

The terminal apparatus used for inputting the order content may be a terminal apparatus assumed to be operated by a salesclerk, and may be a terminal apparatus assumed to be operated by a customer. As the terminal apparatus assumed to be operated by a salesclerk, a handy terminal, a register (for example, a point of sales (POS) register), and the like are exemplified, which are not limited thereto. The terminal apparatus assumed to be operated by a customer may be an order apparatus possessed by a store and installed in the store, or may be a communication terminal possessed by the customer. As the communication terminal possessed by the customer, a smartphone, a cellular phone, a tablet terminal, a smartwatch, a personal computer, and the like are exemplified, which are not limited thereto. When the communication terminal possessed by the customer is used, for example, order processing is performed via a Web page and an application of a store. The processing can be achieved by using various known techniques.

Then, the order management unit 14 newly registers a pre-provision order in the order management information as illustrated in FIGS. 10 and 11, based on the information acquired from the terminal apparatus described above. Information about a plurality of pre-provision orders is registered in the order management information illustrated in FIGS. 10 and 11. Then, for each of the pre-provision orders, a plurality of pieces of information are registered in association with each other.

“Order identification information” is information that identifies a plurality of received orders from each other. For example, new order identification information is issued at a timing at which an order is received. The order identification information illustrated in FIGS. 10 and 11 has a serial number. Thus, an order of received orders can be determined based on a number of the order identification information.

An “order content” indicates a content of a received order. In other words, the order content indicates at least one ordered product or service.

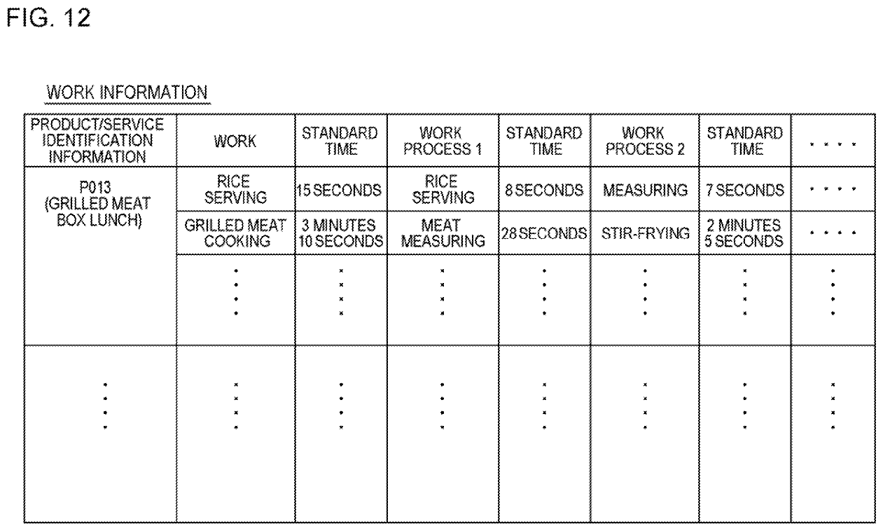

“Work” is at least one piece of work needed to be performed in order to provide each ordered product or service to a customer. A “work process” is at least one work process constituting each piece of work. As illustrated in FIG. 12, work information that defines at least one piece of work needed to be performed in order to provide each product or service to a customer, and at least one work process constituting each piece of work is generated and registered in advance in the waiting time prediction system 10. The work information illustrated in FIG. 12 defines that “rice serving” work, “grilled meat cooking” work, and the like need to be performed for providing a product “grilled meat box lunch”. Further, the work information illustrated in FIG. 12 defines that the “grilled meat cooking” work is formed of a work process such as “meat measuring” and “stir-frying”. A content in a column of the work and a column of the work process of the order management information as illustrated in FIGS. 10 and 11 can be determined based on the information. Note that, a standard time indicated in the work information in FIG. 12 will be described below.

A “status” illustrated in FIGS. 10 and 11 is associated with each work process. The status indicates a state of each work process at a current point in time. The state of each work process includes an “executed” state where processing has already been completed, an “executing” state where processing is currently performed, and an “unexecuted” state where any processing has not yet been performed. At a point in time at which a pre-provision order is newly registered in the order management information, a status of all work processes associated with the pre-provision order is an “unexecuted” status.

### —Status Management of Pre-Provision Order—

The order management unit 14 updates status information of the order management information, based on a determination result by the work process determination unit 12.

First, a work process being performed currently (at a point in time of capturing) by a worker is indicated in a determination result by the work process determination unit 12. The order management unit 14 can change, from an “unexecuted” status to an “executing” status, a status of the work process indicated by the determination result by the work process determination unit 12 (when the status is already the “executing” status, the change is unnecessary). Then, while the work process continues to be indicated in a subsequent determination result by the work process determination unit 12, the order management unit 14 can maintain the status of the work process in the “executing” status. Then, when the work process is not indicated by a subsequent determination result by the work process determination unit 12, the order management unit 14 can change the status of the work process from the “executing” status to an “executed” status.

Note that, a condition that the “work process is not indicated by the subsequent determination result by the work process determination unit 12” may be replaced with a condition that the “work process is not indicated by the subsequent determination result by the work process determination unit 12, and the state continues for a predetermined period of time or longer”, and the like.

A plurality of pre-provision orders including the same product or service in an order content may be registered in the order management information, and, as a result, a plurality of the same work processes may be registered in the order management information. For example, a plurality of pre-provision orders including a product “grilled meat box lunch” may be registered in the order management information, and as a result, a work process such as “rice serving” and “meat measuring” may be registered in the order management information in association with each of the plurality of pre-provision orders. In such a situation, when the work process of “rice serving” is indicated by a determination result by the work process determination unit 12, the work process determination unit 12 can change, from an “unexecuted” status to an “executing” status, a status of the work process associated with the pre-provision order at an earliest ordered timing. Then, the status of the work process associated with the pre-provision order can be changed in response to a change in a subsequent determination result by the work process determination unit 12.

—Deletion of Pre-Provision Order in which Provision is Completed—

The order management unit 14 determines a pre-provision order in which provision is completed by a predetermined means, and deletes the determined pre-provision order from the order management information. There are various means for determining a pre-provision order in which provision is completed.

As one example, determination of a pre-provision order in which provision is completed may be achieved based on a determination result by the work process determination unit 12. For example, as described above, when a status of each of a plurality of work processes requested from each pre-provision order is managed for each pre-provision order, the order management unit 14 may determine, as a pre-provision order in which provision is completed, a pre-provision order in which all of the plurality of work processes are an “executed” work process.

In addition, when accounting processing is performed after provision of a product or a service is completed, the order management unit 14 may determine a pre-provision order in which provision is completed, based on information about the accounting processing. Specifically, the order management unit 14 acquires accounting information from a POS system in a store. Order identification information in which accounting processing is completed is indicated in the accounting information. The order management unit 14 determines a pre-provision order in which provision is completed, based on the accounting information.

Note that, in the present example embodiment, a pre-provision order in which provision is completed is deleted from the order management information, but a pre-provision order in which provision is completed may not be deleted and left in the order management information as it is. In this way, whether provision of each of a plurality of pre-provision orders is completed can also be identified based on a status of each work process.

Returning to FIG. 3, the waiting time computation unit 13 computes a waiting time until a product or a service in a store is provided, based on the determination result of the work process by the work process determination unit 12. The waiting time computation unit 13 can compute the waiting time, based on the order management information described above.

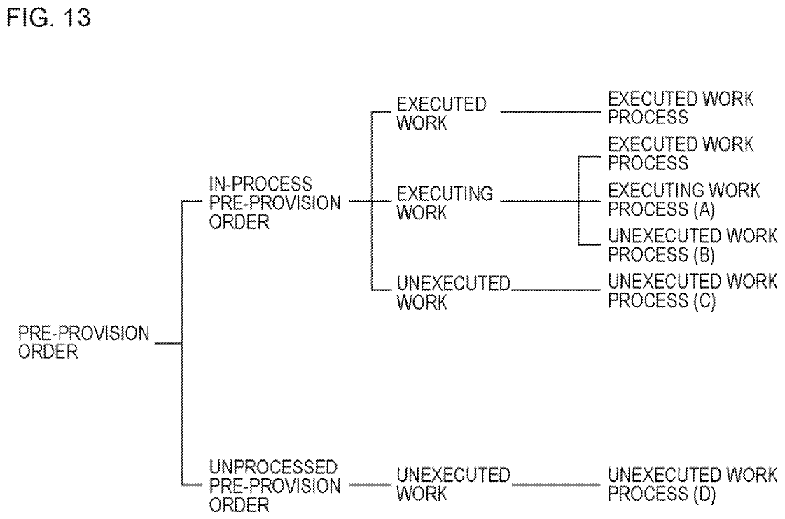

Herein, a method for computing a waiting time will be described in detail. First, as in FIG. 13, a pre-provision order managed by the order management unit 14 is classified into an “in-process pre-provision order” and an “unprocessed pre-provision order”.

The “in-process pre-provision order” is a pre-provision order in which a worker performs some sort of processing for providing a product or a service. For example, the in-process pre-provision order is a pre-provision order in which a status of at least one work process is an “executing” status or an “executed” status in the order management information illustrated in FIGS. 10 and 11.

The “unprocessed pre-provision order” is a pre-provision order in which any processing for providing a product or a service is not performed at a current point in time. For example, the unprocessed pre-provision order is a pre-provision order in which a status of all work processes is an “unexecuted” status in the order management information illustrated in FIGS. 10 and 11.

Work needed to be performed in the in-process pre-provision order in order to provide an ordered product or service to a customer is classified into “executed work”, “executing work”, and “unexecuted work”.

The “executed work” is work in which all work processes constituting the work are completed. In other words, the executed work is work in which a status of all work processes constituting each piece of work is an “executed” status in the order management information illustrated in FIGS. 10 and 11.

The “unexecuted work” is work in which all work processes constituting the work are unexecuted. In other words, the unexecuted work is work in which a status of all work processes constituting each piece of work is an “unexecuted” status in the order management information illustrated in FIGS. 10 and 11.

The “executing work” is work that does not belong to any of the executed work and the unexecuted work.

A work process constituting the executing process is classified into an “executed work process”, an “executing work process”, and an “unexecuted work process”.

The “executed work process” is a work process in which processing is completed. In other words, the executed work process is a work process of an “executed” status in the order management information illustrated in FIGS. 10 and 11.

The “executing work process” is a work process in which processing is being executed. In other words, the executing work process is a work process of an “executing” status in the order management information illustrated in FIGS. 10 and 11.

The “unexecuted work process” is a work process in which processing has not yet been executed. In other words, the executed work process is a work process of an “unexecuted” status in the order management information illustrated in FIGS. 10 and 11.

As illustrated in FIG. 13, all work processes constituting the executed work are the executed work process. Further, as illustrated in FIG. 13, all work processes constituting the unexecuted work are the unexecuted work process.

Further, as illustrated, all pieces of work needed to be performed in the unprocessed pre-provision order in order to provide an ordered product or service to a customer are the unexecuted work. Then, all work processes constituting the unexecuted work are the unexecuted work process.

The waiting time computation unit 13 includes a means for computing a remaining time required for processing of the in-process pre-provision order, and a means for computing a remaining time required for processing of the unprocessed pre-provision order. Then, the waiting time computation unit 13 computes, as the above-described waiting time, a total of the remaining time required for the processing of the in-process pre-provision order and the remaining time required for the processing of the unprocessed pre-provision order. Hereinafter, each of the means will be described in detail.

### —Means for Computing Remaining Time Required for Processing of In-Process Pre-Provision Order—

The waiting time computation unit 13 computes a remaining time required for the processing of the in-process pre-provision order, based on a determination result of a work process by the work process determination unit 12.

Specifically, the waiting time computation unit 13 computes, as the remaining time required for the processing of the in-process pre-provision order, a total of a remaining time required for processing of an “executing work process (A)”, a remaining time required for processing of an “unexecuted work process (B)”, and a remaining time required for processing of an “unexecuted work process (C)” illustrated in FIG. 13.

The waiting time computation unit 13 determines a currently executing work process (the executing work process (A)) and an unexecuted work process (the unexecuted work process (B) and the unexecuted work process (C)), in the processing of the in-process pre-provision order, based on the order management information. Then, the waiting time computation unit 13 computes, as the remaining time required for the processing of the in-process pre-provision order, a total of a remaining time required for the currently executing work process being determined and a remaining time required for the unexecuted work process being determined.

The executed work process is executed, and does not thus need to be considered in the computation of the remaining time required for the processing of the in-process pre-provision order.

### Computation of Remaining Time Required for Processing of “Executing Work Process (A)”

The waiting time computation unit 13 computes, as the remaining time required for the processing of the “executing work process (A)”, a value acquired by subtracting an (elapsed time since the work process starts) from a (standard time of the work process).

A “standard time” is an estimated time required for execution of each work process. As illustrated in FIG. 12, the standard time is predetermined for each work process. The standard time may be a value determined by an operator. In addition, the waiting time prediction system 10 may compute the standard time for each work process. For example, the waiting time prediction system 10 may accumulate performance (a history) of a time being required for each of a plurality of work processes by a plurality of workers and computed based on a determination result by the work process determination unit 12. Then, the waiting time prediction system 10 may compute a statistic (such as an average value, a maximum value, a minimum value, a mode, and a medium value) of the performance information as the standard time of each work process.

An “elapsed time” is computed based on a history of a determination result by the work process determination unit 12. For example, the waiting time computation unit 13 determines a start timing of a work process being currently performed, based on the history of the determination result by the work process determination unit 12. Then, the waiting time computation unit 13 computes, as the elapsed time, a time from the start timing to a current point in time. The start timing is, for example, a “timing at which a state where the work process being currently performed is not determined by the work process determination unit 12 is changed to a state where the work process is determined”.

In this way, the waiting time computation unit 13 can compute an elapsed time being a time that has been required for an executing work process, based on the history of the determination result of the work process by the work process determination unit 12, and can compute a remaining time required for the executing work process, based on the elapsed time. Specifically, the waiting time computation unit 13 can compute, as a remaining time required for the executing work process, a value acquired by subtracting the elapsed time described above from a predetermined standard time required for each work process.

### Computation of Remaining Time Required for Processing of “Unexecuted Work Process (B)”, and Computation of Remaining Time Required for Processing of “Unexecuted Work Process (C)”

The work process determination unit 12 can set the standard time of each work process described above as the remaining time required for the processing of the “unexecuted work process (B)”. Further, the work process determination unit 12 can set the standard time of each work process described above as the remaining time required for the processing of the “unexecuted work process (C)”.

In this way, the waiting time computation unit 13 can compute the remaining time required for the “unexecuted work process (B)” and the “unexecuted work process (C)”, based on the predetermined standard time required for each work process.

### —Means for Computing Remaining Time Required for Processing of Unprocessed Pre-Provision Order—

The waiting time computation unit 13 computes, as a remaining time required for the processing of the unprocessed pre-provision order, a total of a remaining time required for processing of an “unexecuted work process (D)” illustrated in FIG. 13. The work process determination unit 12 can set the standard time of each work process described above as the remaining time required for the processing of the “unexecuted work process (D)”.

In this way, the waiting time computation unit 13 can compute the remaining time required for the processing of the unprocessed pre-provision order, based on the predetermined standard time required for each work process.

The output unit 16 outputs the waiting time computed by the waiting time computation unit 13. For example, an output apparatus may be installed in a store. Then, the output unit 16 may output the computed waiting time via the output apparatus. As the output apparatus, a display, a speaker, and the like are exemplified, which are not limited thereto. In addition, the output unit 16 may display the waiting time computed by the waiting time computation unit 13 on a Web page of a store.

Note that, the waiting time computed by the waiting time computation unit 13 may change every moment in response to progress of work by a worker. The output unit 16 may update, in real time, information being output to an output apparatus and a Web page in response to a change in the waiting time computed by the waiting time computation unit 13. With such a configuration, more highly accurate information can be provided to a customer.

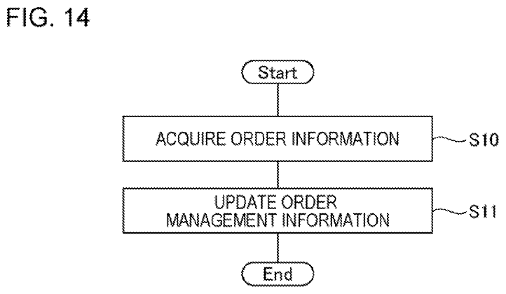

Next, one example of a flow of processing of the waiting time prediction system 10 will be described by using flowcharts in FIGS. 14 to 16. The waiting time prediction system 10 repeatedly performs processing in each of FIGS. 14 to 16.

As illustrated in FIG. 14, when the waiting time prediction system 10 acquires information indicating an order content of a newly received order from a terminal apparatus (S10), the waiting time prediction system 10 updates order management information (S11). Specifically, the waiting time prediction system 10 newly registers a pre-provision order in the order management information as illustrated in FIGS. 10 and 11, based on the information acquired from the terminal apparatus described above. At a point in time at which the pre-provision order is newly registered in the order management information, a status of all work processes associated with the pre-provision order is an “unexecuted” status.

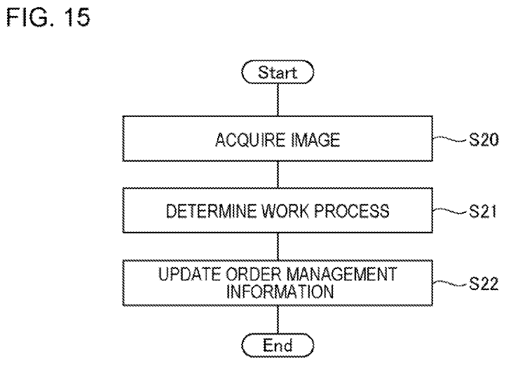

As illustrated in FIG. 15, when the waiting time prediction system 10 acquires an image in which a workspace of a worker is captured (S20), the waiting time prediction system 10 determines, based on the image, which work process is performed by the worker at a point in time at which the image is captured (S21). Then, the waiting time prediction system 10 updates the order management information, based on the determination result of S21 and a history of the determination result (S22). Specifically, the waiting time prediction system 10 can change, from an “unexecuted” status to an “executing” status, a status of the work process indicated by the determination result of S21 (when the status is already the “executing” status, the change is unnecessary). Then, while the work process continues to be indicated in a subsequent determination result of S21, the waiting time prediction system 10 can maintain the status of the work process in the “executing” status. Then, when the work process is not indicated by a subsequent determination result of S21, the waiting time prediction system 10 can change the status of the work process from the “executing” status to an “executed” status.

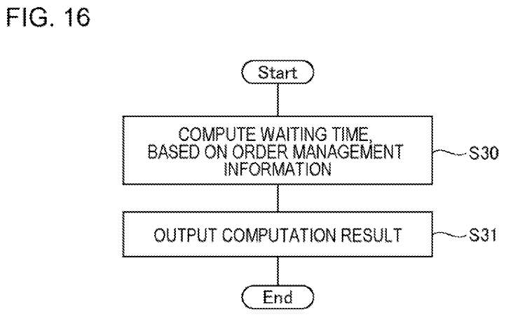

As illustrated in FIG. 16, the waiting time prediction system 10 computes a waiting time until a product or a service in a store is provided, based on newest order management information at that point in time (S30). Then, the waiting time prediction system 10 outputs the computation result of S30 (S31).

### Advantageous Effect

The waiting time prediction system 10 according to the present example embodiment determines a work process being performed by a worker at that point in time, and computes the above-described waiting time, based on the determination result. The waiting time can be computed in consideration of a work situation of the worker, and thus a waiting time until an ordered product is received and a service is received can be more accurately computed.

Further, the waiting time prediction system 10 according to the present example embodiment determines, by an image analysis, a work process being performed by a worker at that point in time. Thus, extra work such as “inputting information for determining a work process” is not requested from a worker.

Further, the waiting time prediction system 10 according to the present example embodiment can determine a processed work process, an unprocessed work process, and a work process being performed by a worker at that point in time, based on a result of an image analysis, and can compute the above-described waiting time, based on the determination result.

Furthermore, a remaining time required for each work process can be computed by a technique suitable for each of an unprocessed work process and a work process being performed by a worker at that point in time, and the above-described waiting time can be computed based on the result. Thus, a waiting time until an ordered product is received and a service is received can be more accurately computed.

### Third Example Embodiment

A waiting time prediction system 10 according to the present example embodiment determines which salesclerk performs each work process, and computes, by further using the determination result, a waiting time until an ordered product is received and a service is received. Details will be described below.

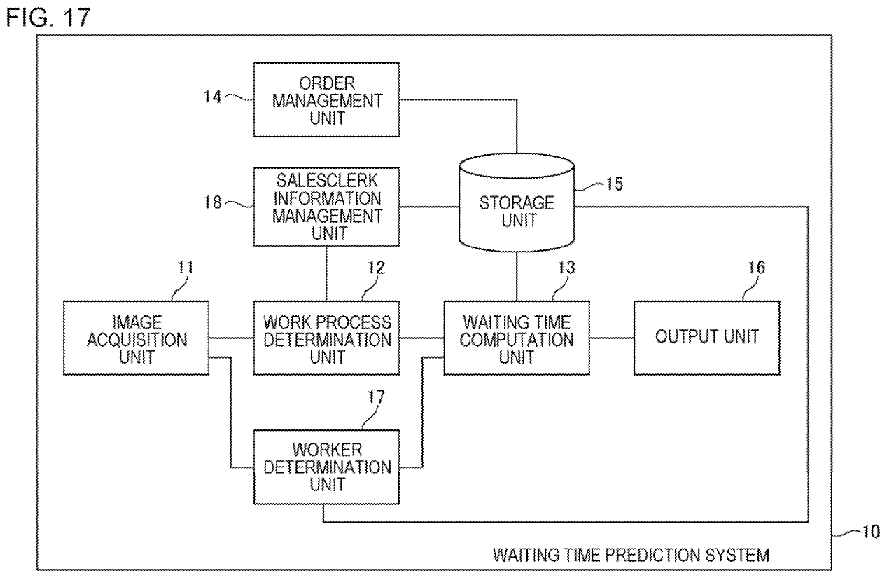

FIG. 17 illustrates one example of a functional block diagram of the waiting time prediction system 10 according to the present example embodiment. As illustrated, the waiting time prediction system 10 includes an image acquisition unit 11, a work process determination unit 12, a waiting time computation unit 13, an order management unit 14, a storage unit 15, an output unit 16, a worker determination unit 17, and a salesclerk information management unit 18.

The worker determination unit 17 determines which salesclerk is a worker who performs a work process determined by the work process determination unit 12.

For example, the worker determination unit 17 may achieve the determination of the salesclerk, based on an image acquired by the image acquisition unit 11. Specifically, a characteristic (such as face information, body shape information, and gait information) of an appearance of each of a plurality of salesclerks belonging to a store is stored in advance in the storage unit 15. Then, the worker determination unit 17 determines, by using the characteristic of the appearance, which salesclerk is a person included in the image acquired by the image acquisition unit 11.

In addition, the worker determination unit 17 may achieve the determination of the salesclerk, based on shift information created in advance and stored in the storage unit 15. A salesclerk who performs each work process in each time period of each business day is determined in the shift information.

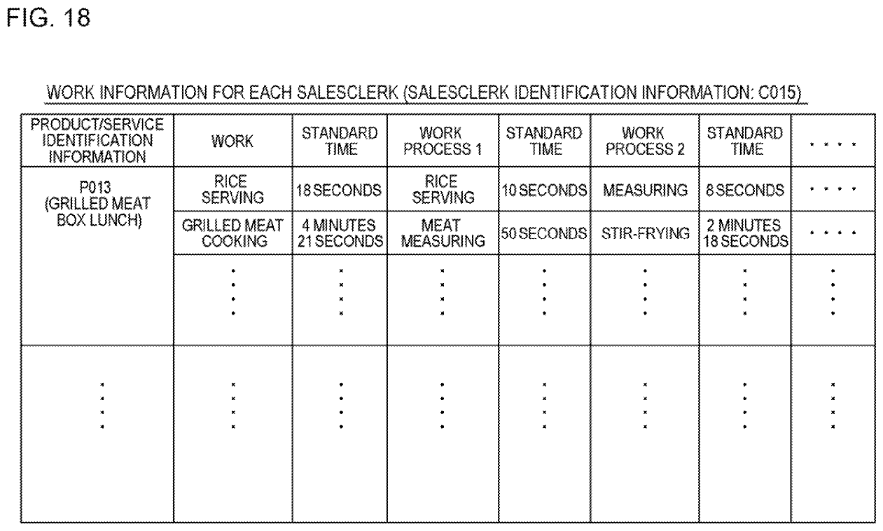

The salesclerk information management unit 18 manages information about each salesclerk. Specifically, the salesclerk information management unit 18 stores, in the storage unit 15, performance (a history) of a time being required for each of a plurality of work processes by each of a plurality of salesclerks and computed based on a determination result by the work process determination unit 12. Then, the salesclerk information management unit 18 computes, for each of the salesclerks, a statistic (such as an average value, a maximum value, a minimum value, a mode, and a medium value) of the performance information as the standard time of each work process described above. In the present example embodiment, as illustrated in FIG. 18, a standard time required for each work process is determined for each of the salesclerks.

The waiting time computation unit 13 determines a standard time used for computing the above-described waiting time, based on the determination result by the worker determination unit 17. Specifically, as illustrated in FIG. 18, the standard time required for each work process is predetermined for each of the salesclerks. The waiting time computation unit 13 determines the standard time required, from the salesclerk determined by the worker determination unit 17, for the work process determined by the work process determination unit 12, based on work information for each of the salesclerks.

Then, the waiting time computation unit 13 computes the above-described waiting time, based on the determined standard time. A computation method is as described in the second example embodiment.

When the number of workers is one, i.e., when all pre-provision orders registered in order management information are processed by one worker, the waiting time computation unit 13 can compute the above-described waiting time by replacing the “standard time” used in the processing described in the second example embodiment with the “standard time” unique to the salesclerk who is determined as described above and performs each work process.

On the other hand, when the number of workers is plural, i.e., when a pre-provision order registered in the order management information is processed by a plurality of workers, for example, the waiting time computation unit 13 can compute a total time required for an executing work process and a total time required for an unexecuted work process as follows. Then, the waiting time computation unit 13 can compute, as the above-described waiting time, a sum of the total time required for the executing work process and the total time required for the unexecuted work process.

### Computation of Total Time Required for Executing Work Process

When a pre-provision order registered in the order management information is processed by a plurality of workers, it is conceivable that the plurality of workers simultaneously perform a plurality of work processes. As a result, it is conceivable that there may be a plurality of the “executing work processes (A)” illustrated in FIG. 13 at a certain point in time. In this case, the waiting time computation unit 13 can compute, as a total time required for processing of the executing work process, a greatest value of a remaining time required for processing of each of the plurality of “executing work processes (A)”.

The remaining time required for the processing of each of the plurality of “executing work processes (A)” can be computed by replacing the “standard time” used in the processing described in the second example embodiment with the “standard time” unique to a salesclerk who is determined as described above and performs each work process.

### Computation of Total Time Required for Unexecuted Work Process

When a plurality of workers simultaneously perform a plurality of work processes, who performs a work process (the unexecuted work process (B), the unexecuted work process (C), and the unexecuted work process (D)) being unexecuted at that point in time is unknown. Thus, the waiting time computation unit 13 may set, as a remaining time required for each of the unexecuted work processes, a statistic (such as an average value, a maximum value, a minimum value, a mode, and a medium value) of a standard time required for each of the unexecuted work processes from each of a plurality of salesclerks who work at that point in time.

Then, the waiting time computation unit 13 may compute, as a total time required for the unexecuted work process, a value acquired by correcting a total of the remaining time required for each of the plurality of unexecuted work processes in consideration of a point that the plurality of workers simultaneously perform the plurality of work processes. The correction is processing of multiplication by a correction coefficient according to the number of workers. One example of the correction coefficient is “1/(the number of workers)”, which is not limited thereto.

Another configuration of the waiting time prediction system 10 according to the present example embodiment is similar to that in the first and second example embodiments.

The waiting time prediction system 10 according to the present example embodiment achieves an advantageous effect similar to that in the first and second example embodiments. Further, the waiting time prediction system 10 according to the present example embodiment can determine which salesclerk performs each work process, and can compute the above-described waiting time in consideration of a speed of a work process different for each salesclerk. Thus, a waiting time until an ordered product is received and a service is received can be more accurately computed.

Further, the waiting time prediction system 10 according to the present example embodiment can compute the above-described waiting time in consideration of a point that a plurality of workers simultaneously perform a plurality of work processes. Thus, a waiting time until an ordered product is received and a service is received can be more accurately computed.

### Fourth Example Embodiment

As described in the second example embodiment, a waiting time prediction system 10 according to the present example embodiment computes, as a remaining time required for processing of an “executing work process (A)”, a value acquired by subtracting an “elapsed time since a work process starts” from a “standard time of the work process”. Work by a worker may be greatly delayed, and an elapsed time may exceed a standard time. In such a case, the waiting time prediction system 10 performs characteristic processing. Specifically, the waiting time prediction system 10 performs “computation of the above-described waiting time in consideration of a delay” and a “notification to a customer in response to a delay”. Hereinafter, each piece of the processing will be described in detail.

“Computation of Above-described Waiting Time in Consideration of Delay”

### Computation Example 1

When an elapsed time exceeds a standard time, the waiting time computation unit 13 can subsequently compute the above-described waiting time by using a standard time after correction greater than the original standard time. Specifically, the waiting time computation unit 13 computes, as a remaining time required for the processing of the “executing work process (A)”, a value acquired by subtracting the “elapsed time” from the “standard time after the correction”. Then, the waiting time computation unit 13 computes the above-described waiting time by using the computation result.

The standard time after the correction may be predetermined for each work process.

In addition, in one example described in the second example embodiment, a statistic (such as an average value, a maximum value, a minimum value, a mode, and a medium value) of performance (a history) of a time required for each of a plurality of work processes by a plurality of workers is set as a standard time of each work process. In a case of this example, a first statistic of the performance (history) of the time required for each of the plurality of work processes by the plurality of workers may be set as the standard time of each work process, and a second statistic may be set as a standard time after correction of each work process. The first statistic and the second statistic are statistics different from each other. The second statistic is always greater than the first statistic. For example, the second statistic is a “maximum value”, and the first statistic is “any of an average value, a minimum value, a mode, and a medium value”.

Further, in one example described in the third example embodiment, a statistic (such as an average value, a maximum value, a minimum value, a mode, and a medium value) of performance (a history) of a time required for each of a plurality of work processes by each salesclerk is set as a standard time of each work process by each salesclerk. In a case of this example, a first statistic of the performance (history) of the time required for each of the plurality of work processes by each salesclerk may be set as the standard time of each work process by each salesclerk, and a second statistic may be set as a standard time after correction of each work process by each salesclerk. The first statistic and the second statistic are statistics different from each other. The second statistic is always greater than the first statistic. For example, the second statistic is a “maximum value”, and the first statistic is “any of an average value, a minimum value, a mode, and a medium value”.

### Computation Example 2

As another example, when an elapsed time exceeds a standard time, the waiting time computation unit 13 may subsequently compute the above-described waiting time by setting a remaining time required for the work process as “0”.

### “Notification to Customer in Response to Delay”

When an elapsed time exceeds a standard time, a delay greater than an assumed delay occurs. Thus, the output unit 16 notifies delay information indicating the delay to a customer. For example, the output unit 16 can output information such as A “delay of work is currently occurring. You may have to wait for longer than a waiting time that has been notified”. The output of the information is achieved via an output apparatus installed in a store and a Web page of a store.

Note that, the output unit 16 may continue the output of the information as described above until processing of a “work process in which an elapsed time exceeds a standard time” is completed. Then, the output unit 16 may stop the output of the information as described above in response to the completion of the processing of the work process. In other words, when the work process in which the elapsed time exceeds the standard time occurs, the output unit 16 may continue the output of the information as described above until the processing of the work process is completed.

In addition, the output unit 16 may continue the output of the information as described above until a predetermined time being predefined has elapsed. Then, the output unit 16 may stop the output of the information as described above in response to the lapse of the predetermined time.

Another configuration of the waiting time prediction system 10 according to the present example embodiment is similar to that in the first to third example embodiments.

The waiting time prediction system 10 according to the present example embodiment achieves an advantageous effect similar to that in the first to third example embodiments. Further, during operation of a store, work may be greatly delayed by an unexpected situation. For example, work may be greatly delayed by material depletion, failure to prepare a material, breakage of a tool, and the like. In such a case, the waiting time prediction system 10 can perform appropriate processing. Specifically, even when work is greatly delayed, the above-described waiting time can be computed in consideration of the situation. Further, the situation can be notified to a customer, and a fact that reliability of a notified waiting time is reduced at a current point in time can be notified to the customer. As a result, stress relief of the customer and the like are achieved.

### Fifth Example Embodiment

A waiting time prediction system 10 according to the present example embodiment has a function of computing a waiting time until a predetermined product or service is provided when the product or the service is temporarily ordered at a current point in time, and notifying the waiting time to a customer. Details will be described below.

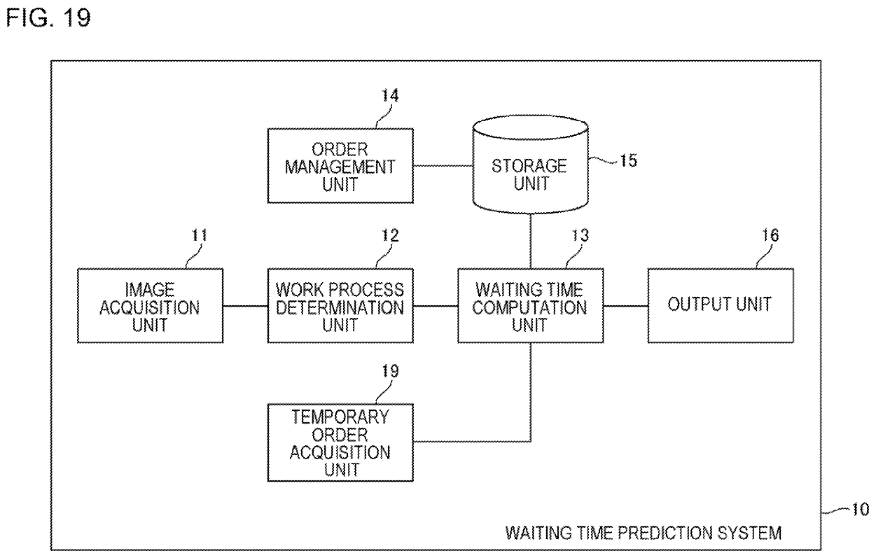

FIG. 19 illustrates one example of a functional block diagram of the waiting time prediction system 10 according to the present example embodiment. As illustrated, the waiting time prediction system 10 includes an image acquisition unit 11, a work process determination unit 12, a waiting time computation unit 13, an order management unit 14, a storage unit 15, an output unit 16, and a temporary order acquisition unit 19. Note that, although not illustrated, the waiting time prediction system 10 may further include a worker determination unit 17 and a salesclerk information management unit 18.

The temporary order acquisition unit 19 acquires temporary order information. The temporary order information indicates at least one product or service. Note that, even when the temporary order acquisition unit 19 acquires the temporary order information, it does not mean that a formal order is received. Thus, even when the temporary order acquisition unit 19 acquires the temporary order information, the order management unit 14 does not register a content of the temporary order information in the order management information (see FIGS. 10 and 11).

The temporary order information may be generated based on, for example, an input of a customer. For example, it is assumed that a flow of a received order based on an input of a customer is that (1) a product or a service selected by the customer via a terminal apparatus is put in a cart, and (2) the product or the service put in the cart is confirmed on a confirmation screen displayed on the terminal apparatus, and then the product or the service put in the cart at that point in time is formally ordered in response to an operation of a confirmation button. In this case, the temporary order acquisition unit 19 may generate temporary order information indicating the product or the service put in the cart.

In addition, the temporary order information may be generated based on, for example, an input of a salesclerk. For example, it is assumed that a flow of a received order based on an input of a salesclerk is that (1) a product or a service selected by a customer is input as a temporary order by an operation of a terminal apparatus by the salesclerk, and (2) a confirmation screen indicating a list of a temporarily ordered product or service is displayed on the terminal apparatus, and then the salesclerk confirms, with the customer, that the temporarily ordered product or service is correct, and the product or the service being temporarily ordered at that point in time is formally ordered in response to a subsequent operation of a confirmation button by the salesclerk. In this case, the temporary order acquisition unit 19 may generate temporary order information indicating the product or the service specified as the temporary order.

In addition, the temporary order acquisition unit 19 may generate the temporary order information by other processing. For example, the temporary order acquisition unit 19 may generate the temporary order information indicating a product or a service registered as a popular product or a popular service, a product registered as a sales promotion product or a service, and the like.

When a product or a service indicated by the temporary order information is temporarily ordered at a current point in time, the waiting time computation unit 13 computes a waiting time (temporary waiting time) required until the product or the service is provided. The waiting time computation unit 13 computes, as the temporary waiting time until the product or the service indicated by the temporary order information is provided, a total of a time required for providing the product or the service indicated by the temporary order information, and the above-described waiting time computed by the technique described in the example embodiment described above.

The time required for the provision of the product or the service indicated by the temporary order information can be achieved similarly to the computation of a remaining time required for the processing of the “unprocessed pre-provision order” described in the example embodiment described above. All pieces of work needed to be performed in order to provide the product or the service indicated by the temporary order information to a customer are an unexecuted work. Then, all work processes constituting the unexecuted work are an unexecuted work process.

The output unit 16 outputs the temporary waiting time computed by the waiting time computation unit 13.

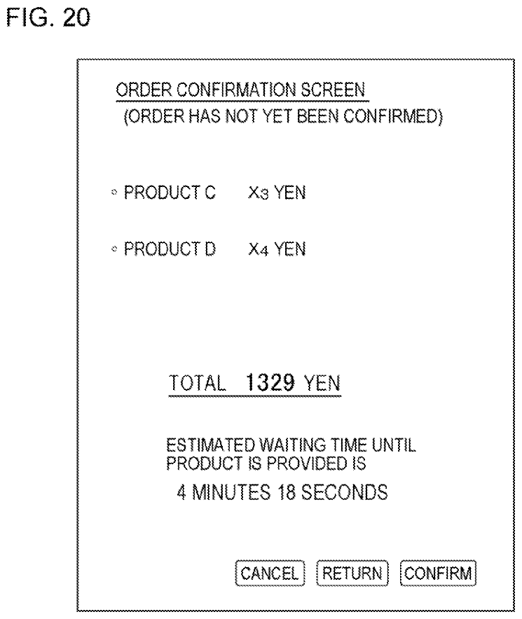

As described above, when the temporary order acquisition unit 19 generates the temporary order information, based on an input of a customer, the output unit 16 may display the temporary waiting time on the confirmation screen described above. FIG. 20 illustrates one example of the confirmation screen. The confirmation screen indicates a product or a service being put in a cart, and also indicates the temporary waiting time described above.

In addition, as described above, when the temporary order acquisition unit 19 generates the temporary order information, based on an input of a salesclerk, the output unit 16 may display the temporary waiting time on the confirmation screen described above. In addition, every time one product or service is specified as a temporary order, in response to the specification, the output unit 16 may display, on a terminal apparatus, a temporary waiting time required until the specified product or service is provided. In such a case, every time an order of a product or a service is received from a customer, a salesclerk can immediately notify, to a customer, a waiting time required until the product or the service is provided.

In addition, as described above, when the temporary order acquisition unit 19 generates the temporary order information indicating a product or a service registered as a popular product or a popular service, and a product registered as a sales promotion product or a service, the output unit 16 may display, on an output apparatus installed in a store and a Web page of a store, a temporary waiting time as a waiting time required until the products or the services are provided. For example, the output unit 16 may display, on an output apparatus installed in a store and a Web page of a store, information such as “Recommended product: most popular product Ain our store. If you order it now, we can provide the product in oo minutes”.

Another configuration of the waiting time prediction system 10 according to the present example embodiment is similar to that in the first to fourth example embodiments.

The waiting time prediction system 10 according to the present example embodiment achieves an advantageous effect similar to that in the first to fourth example embodiments. Further, the waiting time prediction system 10 according to the present example embodiment can compute a waiting time until a predetermined product or service is provided when the product or service is temporarily ordered at a current point in time, and can notify the waiting time to a customer. The customer can order a product or a service having a preferable waiting time, based on such information. As a result, stress of the customer due to a waiting time being unintentionally long can be relieved.

### Modification Example

The first to fifth embodiments can be modified as follows. An advantageous effect similar to that in the example embodiments described above is also achieved in the modification example.

As described above, by detecting, in an image, a characteristic of an appearance of a work target object, a characteristic of a worktable, a surrounding characteristic of the work target object, a characteristic of a position of the work target object, a characteristic of a hand of a worker, and a characteristic of a tool to be used that are registered in advance when each of a plurality of work processes is performed, the work process determination unit 12 determines a work process being performed at a point in time at which each image is captured.

As a modification example of the processing, the work process determination unit 12 may determine an executing work process and an unexecuted work process, based on the order management information (see FIGS. 10 and 11) managed by the order management unit 14, and may perform the detection processing described above by using only the characteristic described above of the determined executing work process and the determined unexecuted work process. A work process performed by a worker is only a work process related to an ordered product or service, and a work process related to a product or a service that is not ordered is not performed. Further, the work process performed by the worker is only a work process in which processing has not yet been completed at that point in time. In consideration of this point, as described above, information (the characteristic described above) referred in processing of determining a work process being performed by a worker can be narrowed down. As a result, a reduction in processing load on a computer, an improvement in a calculation speed, and the like are expected.

While the example embodiments of the present invention have been described with reference to the drawings, the example embodiments are only exemplification of the present invention, and various configurations other than the above-described example embodiments can also be employed. The configurations of the example embodiments described above may be combined together, or a part of the configuration may be replaced with another configuration. Further, various modifications may be made in the configurations of the example embodiments described above without departing from the scope of the present invention. Further, the configurations and the processing disclosed in each of the example embodiments and the modification examples described above may be combined together.

Further, the plurality of steps (pieces of processing) are described in order in the plurality of flowcharts used in the above-described description, but an execution order of steps performed in each of the example embodiments is not limited to the described order. In each of the example embodiments, an order of illustrated steps may be changed within an extent that there is no harm in context. Further, each of the example embodiments described above can be combined within an extent that a content is not inconsistent.

A part or the whole of the above-described example embodiments may also be described in supplementary notes below, which is not limited thereto.
1. A waiting time prediction system including:
   an image acquisition unit that acquires an image in which a workspace of a worker in a store that provides a product or a service is captured;
   a work process determination unit that determines which work process is performed by the worker at a point in time at which the image is captured, based on the image; and
   a waiting time computation unit that computes a waiting time until a product or a service in the store is provided, based on a determination result of the work process.
2. The waiting time prediction system according to supplementary note 1, further including
   an order management unit that manages order management information indicating a received order before provision and an order content of each of the orders, wherein
   the waiting time computation unit further computes the waiting time, based on the order management information.
3. The waiting time prediction system according to supplementary note 2, wherein
   the waiting time computation unit
   includes a unit that computes a remaining time required by the worker for processing of the order during processing, and
   a unit that computes a remaining time required for processing of the order that is not processed, by the worker, and
   computes, as the waiting time, a total of a remaining time required for processing of the order during the processing and a remaining time required for processing of the order that is not processed.
4. The waiting time prediction system according to supplementary note 3, wherein
   the waiting time computation unit computes a remaining time required for processing of the order during the processing, based on a determination result of the work process.
5. The waiting time prediction system according to supplementary note 4, wherein
   execution of one or a plurality of pieces of work is requested in processing of each of the orders,
   each piece of the work is formed of one or a plurality of the work processes, and
   the waiting time computation unit
      determines the work process being currently executed and the work process that is not executed in processing of the order during the processing, and
      computes, as a remaining time required for processing of the order during the processing, a total of a remaining time required for the determined work process being currently executed and a remaining time required for the determined work process that is not executed.
6. The waiting time prediction system according to supplementary note 5, wherein
   the waiting time computation unit computes an elapsed time being a time that has been required for the determined work process being currently executed, based on a history of a determination result of the work process, and computes a remaining time required for the determined work process being currently executed, based on the elapsed time.
7. The waiting time prediction system according to supplementary note 6, wherein
   the waiting time computation unit computes, as a remaining time required for the determined work process being currently executed, a value acquired by subtracting the elapsed time from a predetermined standard time required for each of the work processes.
8. The waiting time prediction system according to any one of supplementary notes 5 to 7, wherein
   the waiting time computation unit computes a remaining time required for the determined work process that is not executed, based on a predetermined standard time required for each of the work processes.
9. The waiting time prediction system according to supplementary note 3, wherein
   the waiting time computation unit computes a remaining time required for processing of the order that is not processed, based on a predetermined standard time required for each of the work processes.
10. The waiting time prediction system according to any one of supplementary notes 7 to 9, wherein
   the standard time is determined for each salesclerk,
   the waiting time prediction system further including a worker determination unit that determines which salesclerk is the worker, wherein
   the waiting time computation unit determines the standard time, based on a determination result of the worker.
11. The waiting time prediction system according to supplementary note 10, further including
   a salesclerk information management unit that computes performance of a time required for each of the work processes by each salesclerk, based on a history of a determination result of the work process, and computes the standard time for each salesclerk, based on the performance.
12. The waiting time prediction system according to supplementary note 11, wherein
   the salesclerk information management unit computes an average value of the performance as the standard time, and
   the waiting time computation unit
      computes, as a remaining time required for the determined work process being currently executed, a value acquired by subtracting the elapsed time from the predetermined standard time required for each of the work processes, and
      computes, as a remaining time required for the determined work process being currently executed, a value acquired by subtracting the elapsed time from a maximum value of the performance when the elapsed time exceeds the standard time.
13. The waiting time prediction system according to supplementary note 12, further including
   an output unit that outputs delay information indicating a delay of work when the elapsed time exceeds the standard time.
14. The waiting time prediction system according to any one of supplementary notes 10 to 13, wherein
   the worker determination unit determines which salesclerk works as the worker, based on the image or based on shift information.
15. The waiting time prediction system according to any one of supplementary notes 2 to 14, further including
   a temporary order acquisition unit that acquires temporary order information indicating a product or a service, wherein
   the waiting time computation unit computes, as a temporary waiting time until a product or a service indicated by the temporary order information is provided, a total of a time required for providing a product or a service indicated by the temporary order information, and the waiting time.
16. The waiting time prediction system according to supplementary note 1, further including
   a worker determination unit that determines which salesclerk is the worker, wherein
   the waiting time computation unit further computes the waiting time, based on a determination result of the worker.
17. Awaiting time prediction method including,
   by one or more computers:
   acquiring an image in which a workspace of a worker in a store that provides a product or a service is captured;
   determining which work process is performed by the worker at a point in time at which the image is captured, based on the image; and
   computing a waiting time until a product or a service in the store is provided, based on a determination result of the work process.
18. A program causing a computer to function as:
   an image acquisition unit that acquires an image in which a workspace of a worker in a store that provides a product or a service is captured;
   a work process determination unit that determines which work process is performed by the worker at a point in time at which the image is captured, based on the image; and
   a waiting time computation unit that computes a waiting time until a product or a service in the store is provided, based on a determination result of the work process.
10 Waiting time prediction system
11 Image acquisition unit
12 Work process determination unit
13 Waiting time computation unit
14 Order management unit
15 Storage unit
16 Output unit
17 Worker determination unit
18 Salesclerk information management unit
19 Temporary order acquisition unit
1A Processor
2A Memory
3A Input/output I/F
4A Peripheral circuit
5A Bus

1. A waiting time prediction system comprising:
at least one memory configured to store one or more instructions; and
at least one processor configured to execute the one or more instructions to:
acquire an image in which a workspace of a worker in a store that provides a product or a service is captured;
determine which work process is performed by the worker at a point in time at which the image is captured, based on the image; and
compute a waiting time until a product or a service in the store is provided, based on a determination result of the work process.

2. The waiting time prediction system according to claim 1,
wherein the processor is further configured to execute the one or more instructions to:
manage order management information indicating a received order before provision and an order content of each of the orders, and
compute the waiting time, based on the order management information.

3. The waiting time prediction system according to claim 2,
wherein the processor is further configured to execute the one or more instructions to:
compute a remaining time required by the worker for processing of the order during processing,
compute a remaining time required for processing of the order that is not processed, by the worker, and
compute, as the waiting time, a total of a remaining time required for processing of the order during the processing and a remaining time required for processing of the order that is not processed.

4. The waiting time prediction system according to claim 3,
wherein the processor is further configured to execute the one or more instructions to compute a remaining time required for processing of the order during the processing, based on a determination result of the work process.

5. The waiting time prediction system according to claim 4,
wherein execution of one or a plurality of pieces of work is requested in processing of each of the orders,
wherein each piece of the work is formed of one or a plurality of the work processes, and
wherein the processor is further configured to execute the one or more instructions to:
determine the work process being currently executed and the work process that is not executed in processing of the order during the processing, and
compute, as a remaining time required for processing of the order during the processing, a total of a remaining time required for the determined work process being currently executed and a remaining time required for the determined work process that is not executed.

6. The waiting time prediction system according to claim 5,
wherein the processor is further configured to execute the one or more instructions to compute an elapsed time being a time that has been required for the determined work process being currently executed, based on a history of a determination result of the work process, and compute a remaining time required for the determined work process being currently executed, based on the elapsed time.

7. The waiting time prediction system according to claim 6,
wherein the processor is further configured to execute the one or more instructions to compute, as a remaining time required for the determined work process being currently executed, a value acquired by subtracting the elapsed time from a predetermined standard time required for each of the work processes.

8. The waiting time prediction system according to claim 5,
wherein the processor is further configured to execute the one or more instructions to compute a remaining time required for the determined work process that is not executed, based on a predetermined standard time required for each of the work processes.

9. The waiting time prediction system according to claim 3,
wherein the processor is further configured to execute the one or more instructions to compute a remaining time required for processing of the order that is not processed, based on a predetermined standard time required for each of the work processes.

10. The waiting time prediction system according to claim 7,
wherein the standard time is determined for each salesclerk,
wherein the processor is further configured to execute the one or more instructions to:
determine which salesclerk is the worker, and
determine the standard time, based on a determination result of the worker.

11. The waiting time prediction system according to claim 10,
wherein the processor is further configured to execute the one or more instructions to compute performance of a time required for each of the work processes by each salesclerk, based on a history of a determination result of the work process, and compute the standard time for each salesclerk, based on the performance.

12. The waiting time prediction system according to claim 11,
wherein the processor is further configured to execute the one or more instructions to:
compute an average value of the performance as the standard time, compute, as a remaining time required for the determined work process being currently executed, a value acquired by subtracting the elapsed time from the predetermined standard time required for each of the work processes, and
compute, as a remaining time required for the determined work process being currently executed, a value acquired by subtracting the elapsed time from a maximum value of the performance when the elapsed time exceeds the standard time.

13. The waiting time prediction system according to claim 12,
wherein the processor is further configured to execute the one or more instructions to output delay information indicating a delay of work when the elapsed time exceeds the standard time.

14. The waiting time prediction system according to claim 10,
wherein the processor is further configured to execute the one or more instructions to determine which salesclerk works as the worker, based on the image or based on shift information.

15. The waiting time prediction system according to claim 2,
wherein the processor is further configured to execute the one or more instructions to:
acquire temporary order information indicating a product or a service, and
compute, as a temporary waiting time until a product or a service indicated by the temporary order information is provided, a total of a time required for providing a product or a service indicated by the temporary order information, and the waiting time.

16. The waiting time prediction system according to claim 1,
wherein the processor is further configured to execute the one or more instructions to:
determine which salesclerk is the worker, and
compute the waiting time, based on a determination result of the worker.

17. A waiting time prediction method comprising,
by one or more computers:
acquiring an image in which a workspace of a worker in a store that provides a product or a service is captured;
determining which work process is performed by the worker at a point in time at which the image is captured, based on the image; and
computing a waiting time until a product or a service in the store is provided, based on a determination result of the work process.

18. A non-transitory storage medium storing a program causing a computer to:
acquire an image in which a workspace of a worker in a store that provides a product or a service is captured;
determine which work process is performed by the worker at a point in time at which the image is captured, based on the image; and
compute a waiting time until a product or a service in the store is provided, based on a determination result of the work process.
